(19) United States
(12) Patent Application Publication
(10) Pub. No.: US 2012/0280426 A1
(43) Pub. Date: Nov. 8, 2012

(54) MANUFACTURING METHOD OF DECORATING MOLDING

(76) Inventors: Kiminori Amaya, Kanagawa (JP); Koji Tsuda, Kanagawa (JP)

(21) Appl. No.: 13/519,019

(22) PCT Filed: Dec. 20, 2010
(86) PCT No.: PCT/US10/61212

§ 371 Date: Jun. 25, 2012

(30) Foreign Application Priority Data
Dec. 28, 2009 (JP) 2009-296921

(51) Int. Cl. B29C 45/14

(52) U.S. Cl. 264/279

(57) ABSTRACT

A manufacturing method of a decorative molding having uneven pattern by a film injection molding process with a decorative sheet comprising a thermoplastic surface layer having uneven structure and a thermoplastic substrate layer comprising a step of producing a pre-decorative sheet by preparing a thermoplastic surface-protection-layer having uneven structure, producing a thermoplastic surface layer by coating thermoplastic resin on the uneven structured surface of the thermoplastic surface-protection-layer, and producing a substrate layer on the opposite side of the thermoplastic surface layer from the thermoplastic surface-protection-layer.

### TECHNICAL FIELD

The present invention relates to decorative moldings, in particular to method of manufacturing a decorative molding, and more particularly to a manufacturing method of a decorative molding having relief pattern by a film injection molding process with a decorative sheet.

### BACKGROUND TECHNOLOGY

It is very popular that decorative articles using for automobile interior, home electronics or office automation equipments, which have relief patterns on its surface to add a depth feel to its metallic or wooden design and an expensive-looking The decorative articles with the expensive-looking add high value to the articles using automobile, home electronics or office automation equipments, and tend to improve advantage of the products in the market, therefore to provide design and relief pattern desired is important.

Generally the decorative articles are manufactured by combining a decorative sheet and a plastic member by a film injection molding process after preparing the decorative sheet with desired metallic or wooden design. The costs tend to be high in the film injection molding and relief pattern making simultaneously on the decorative sheet surface with a molding die having the relief patterns due to requirement of changing the molding die depending on designs desired. It tends to be difficult to maintain the surface relief pattern due to tension or heat by molding in case performing the film injection molding after making relief patterns on the decorative sheet surface.

It is desired to obtain a decorative article still having an excellent fine relief pattern after the film injection molding process.

JP2007-160841A describes an efficiently manufacturing method of the plastic molded body having the embossed pattern on its surface comprises removing a mold release film after setting a thermoplastic sheet having an embossed surface on its surface and a pattern layer on its back surface and performing an injection molding process.

### SUMMARY OF THE INVENTION

One objective of the invention can be to provide a manufacturing method of a decorative molding having an excellent fine relief pattern (uneven pattern) accurately reflecting a surface pattern of the thermoplastic surface-protection-layer. Another objective of the invention can be to provide a decorative molding having an excellent fine relief pattern accurately reflecting a surface uneven pattern of the thermoplastic surface-protection-layer even after the film injection molding process.

In one aspect of the present invention, a method is provided for manufacturing a decorative molding having uneven relief pattern by a film injection molding process with a decorative sheet comprising a thermoplastic surface layer having uneven structure and a thermoplastic substrate layer comprising a step of producing a pre-decorative sheet by preparing a thermoplastic surface-protection-layer having uneven structure, producing a thermoplastic surface layer by coating thermoplastic resin on the uneven structured surface of the thermoplastic surface-protection-layer, and producing a substrate layer on the opposite side of the thermoplastic surface layer from the thermoplastic surface-protection-layer

### EFFECT OF THE INVENTION

In another aspect of the present invention. a method is provided for manufacturing a decorative molding, which has a complementary relief pattern to a pattern on the thermoplastic surface-protection-layer on its surface and keeps an excellent fine pattern on the surface after the film injection molding process.

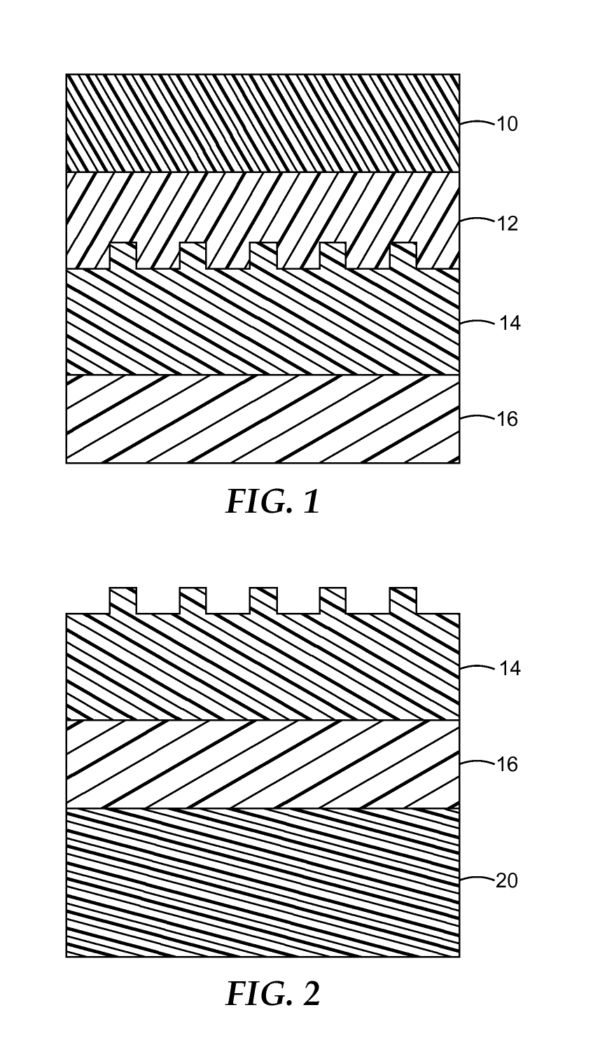

### BRIEF DESCRIPTION OF THE DRAWINGS

[FIG. 1] A cross-sectional view of one embodiment of the pre-decorative sheet of the present invention.

[FIG. 2] A cross-sectional view of one embodiment of the decorative molding of the present invention.

### BEST MODE FOR CARRYING OUT THE INVENTION

Referring to FIG. 1, a pre-decorative sheet includes a thermoplastic surface-protection-layer 12, a thermoplastic surface layer 14 and a substrate layer 16, in this order. The pre-decorative sheet may further include a support layer 10 on the outside or exposed surface of the thermoplastic surface-protection-layer 12.

Referring to FIG. 2, the present invention includes a step of producing a pre-decorative sheet in a manufacturing method of a decorative molding which comprises a decorative sheet comprising a thermoplastic surface layer 14 having relief structure and a thermoplastic substrate layer 16, and a plastic substrate 20.

The method of producing the pre-decorative sheet may include steps of: preparing a thermoplastic surface-protection-layer having uneven structure, producing a thermoplastic surface layer by coating thermoplastic resin on the uneven structured surface of the thermoplastic surface-protection-layer, and producing a substrate layer on the opposite side of the thermoplastic surface layer from the thermoplastic surface-protection-layer, in this order.

Specifically, the uneven pattern is applied on the thermoplastic surface-protection-layer by known methods such as, for example, embossing, scratching, lasering, dry etching or heat pressing, then the surface layer is produced by coating thermoplastic resin on the uneven structured surface of the thermoplastic surface-protection-layer. The thermoplastic resin coating includes known methods such as, for example, casting, bar coating, knife coating or comma coating. When the resin includes solvent, the coating is followed by drying process. The drying process condition may be properly-selected based on amount or kinds of resin.

Then the substrate layer is produced on the surface of the obtained thermoplastic surface layer. The substrate layer can be laminated on the thermoplastic surface layer by known methods such as, for example, heat lamination or extrusion. Alternatively, the substrate layer can be adhered on the thermoplastic surface layer by providing an adhesive layer between them.

When the adhesive layer is provided between the substrate layer and the thermoplastic surface layer, the adhesive layer can be formed by coating adhesive resin on the substrate layer and/or thermoplastic surface layer and drying, or by coating the adhesive resin on a release film and drying.

A support layer can be laminated outside surface of the thermoplastic surface-protection-layer. In this case, the thermoplastic surface-protection-layer is laminated on the support layer, and then the uneven pattern can be applied on the thermoplastic surface-protection-layer surface (opposite surface from the support layer).

The thermoplastic surface-protection-layer can be laminated on the support layer by adhesion, heat lamination, or coating or casting the thermoplastic surface-protection-layer on the support layer. Known heat sensitive adhesive or pressure sensitive adhesive can be coated between the thermoplastic surface-protection-layer and the support layer for adhesion. The heat sensitive adhesives or pressure sensitive adhesives can be coated at least one side of the thermoplastic surface-protection-layer and the support layer. When the resin includes solvent, the coating is followed by drying process.

Elongation or deformation of the pre-decorative sheet by tension or heat in the manufacturing process can be avoided by the support layer.

The support layer includes, but is not limited to, known resin films such as, for example, polyester films such as polyethylene terephthalate (PET) films or polyethylene naphthalate (PEN) films, polyimide films or polypropylene (PP) films.

The thickness of the support layer can be properly selected, but can be, for example, about 5 μm to about 300 μm.

The thermoplastic surface-protection-layer includes thermoplastic resin films. The thermoplastic resin includes, but is not limited to, for example, fluororesins, polyesters such as polyethylene terephthalate (PET) or polyethylene naphthalate(PEN), acrylic resins, polyethylene, polypropylene, thermoplastic elastomers, polycarbonate, poly amides, ABS resin, acrylonitrile-styrene, polystyrene, polyurethanes, vinyl chloride or amorphous polyesters. These resins can be used alone or in combination.

The thermoplastic resin includes, but is not limited to, for example, fluororesin, polyesters such as polyethylene terephthalate (PET) or polyethylene naphthalate(PEN), acrylic resins, polyethylene, polypropylene, thermoplastic elastomers, polycarbonate, poly amides, ABS resin, acrylonitrile-styrene, polystyrene, polyurethanes or vinyl chloride. These resins can be used alone or in combination. These resins may further include known additives such as cross-linkers, unless they result in negative effects such as cracks or insufficient elongation characteristic.

The cross-linkers include known cross-linkers. Specifically the cross-linkers include, for example, bisamide cross-linkers, aziridine cross-linkers, carbodiimide cross-linkers, epoxy cross-linkers, isocyanate cross-linkers or metallic cross-linkers.

The combinations of the resins consisting of the thermoplastic surface-protection-layer and those consisting of the thermoplastic surface layer can be, but are not limited to, properly selected. Preferred combinations include the thermoplastic surface-protection-layer which is easy to remove from the thermoplastic surface layer, and the thermoplastic surface-protection-layer may be coated with known release agents then coated with the thermoplastic surface layer on the release agents if adhesion between the thermoplastic surface-protection-layer and the thermoplastic layer is too high to remove. Examples of the combinations include polyolefins such as polyethylene or polypropylene for the thermoplastic surface-protection-layer and acrylic resin or polyurethane for the thermoplastic surface layer.

The thickness of the thermoplastic surface-protection-layer and the thermoplastic surface layer can be, but is not limited to, selected based on the depth of the uneven pattern, and it can be respectively from about 10 μm to about 1000 μm.

The thermoplastic resin of the substrate layer includes, but is not limited to, for example, ABS resin, polyethylene, polypropylene, polycarbonate or vinyl chloride.

The thickness of the substrate layer can be, but is not limited to, for example, about 50 μm to about 3000 μm, or preferably about 100 μm to about 1000 μm.

The resin for the adhesive layer includes known heat sensitive adhesive or pressure sensitive adhesive, for example, heat sensitive adhesive or pressure sensitive adhesive such as acrylic adhesive, urethane adhesive, silicon adhesive, polyester adhesive or rubber adhesive. Known cross-linkers can be added to those heat sensitive adhesives or pressure sensitive adhesives.

The pre-decorative sheet obtained by the above process is used in the following film injection molding process.

The film injection molding process includes placing the pre-decorative sheet to a molding die, and injecting molten thermoplastic resin consisting of the plastic substrate to the substrate layer side of the pre-decorative sheet. The injected molten thermoplastic resin is cured to form the plastic substrate, then the pre-decorative sheet and the plastic substrate are integrally-molded.

Alternatively, in this process, the plain pre-decorative sheet placed in the molding die may be positioned in the die with a vacuum assist and to form in three dimensional shapes by vacuum forming, pressure forming or vacuum-pressure forming, then the formed pre-decorative sheet and the plastic substrate may be integrally-molded. In this step, the plain pre-decorative sheet may be formed in three dimensional shapes and de-placed from the molding die, trimmed if necessary, then placed in the injection molding die, injected melted resin and molded integrally with the plastic substrate.

Further the plain pre-decorative sheet may be placed in the molding die and injected molten resin simultaneously. In each injection molding process above, ordinary temperature can be used.

Subsequently, the thermoplastic surface-protection-layer is peeled off from the integrally-molded pre-decorative sheet and plastic substrate to form the decorative molding.

If the support layer is laminated on the pre-decorative sheet, the pre-decorative sheet may be placed in the injection molding die after removing the support layer.

The plastic substrate includes thermoplastic resin, for example, thermoplastic resin compatible with the substrate layer resin. For example, if the substrate layer is ABS resin, ABS resin or a polymer alloy of ABS resin and polycarbonate can be used as the plastic substrate.

The thickness of the plastic substrate includes, but is not limited to, for example, about 1 mm to about 5 mm.

In the present invention, the complementary uneven pattern to the thermoplastic surface-protection-layer surface may be applied on the surface of the thermoplastic surface layer by coating resins on the thermoplastic surface-protection-layer having the uneven pattern for forming the pattern of the thermoplastic surface layer.

The decorative molding having the complementary uneven pattern to the thermoplastic surface-protection-layer surface can be obtained by the film injection molding with the pre-decorative sheet having the thermoplastic surface-protection-layer.

Further, the decorative molding still having the complementary uneven pattern to the thermoplastic surface-protection-layer surface without deformation or breaking of the surface pattern by the film injection molding can be obtained by peeling off the thermoplastic surface-protection-layer from the pre-decorative sheet after the film injection molding process.

To the thermoplastic surface layer and/or the substrate layer, colors may be added with known colorants. The colorants include, for example, color pigments, metallic pigments, interference color pigments or fluorescent pigments. The amount of the colorants may be properly selected based on kinds of the colorants or colors desired.

Further, a decorative layer or a metal evaporated layer may be formed between the thermoplastic surface layer and the substrate layer to improve decorativeness more. The decorative layer may be formed on the opposite plain surface of the thermoplastic surface layer from the thermoplastic surface-protection-layer and/or the thermoplastic surface layer side surface of the substrate layer by known methods such as offset printing, gravure printing or screen printing. The metal evaporated layer may be formed on the opposite plain surface of the thermoplastic surface layer from the thermoplastic surface-protection-layer and/or the thermoplastic surface layer side surface of the substrate layer by evaporating metals such as aluminum, nickel, titan, cupper, tin or indium. Alternatively the metal evaporated layer may be formed by laminating metal evaporated films between the thermoplastic surface layer and the substrate layer.

Combinations of the decorative layer and metal evaporated layer and the uneven patter of the thermoplastic surface layer may provide the decorative molding having the designs or colors desired.

The following abbreviations may be used in the present specification.

MMA: methyl methacrylate

HEMA: 2-hydroxy ethyl methacrylate

PC: polycarbonate

PET: polyethylene terephthalate

PEN: polyethylene naphthalate

PP: polypropylene

ABS: acrylonitrile-butadiene-styrene

### EXAMPLES

Production of the Pre-Decorative Sheet

Heat sensitive adhesive (polyester polyol E-295NT : isocyanate C-55, both from Dainichiseika Color and Chemicals Mfg. Co. LTD., =100:3) was coated on a 50 μm thick of polyester film (Teijin Tetron G2 from Teijin DuPont films Limited) by gravure coating and dried for five minutes at 100 degrees C., then a 60 μm thick of polypropylene film was laminated on the adhesive surface to form a laminate. Relief pattern (uneven pattern) was made on the polypropylene film side of the obtained laminate by embossing, then acrylic resin (30:0.81 mixture (in solid) of MMA:HEMA=97:3 and isocyanate TPA-100 from Asahi Kasei, Mn=56,000, Mw=130,000) was coated on the embossed surface by casting and dried for five minutes at 120 degrees C. to form a thermoplastic surface layer with the relief pattern (uneven pattern). The thickness of the thermoplastic surface layer was 60 μm. The emboss roll temperature during embossing was 50 degrees C. and the laminate temperature before embossing was 120 to 130 degrees C. Heat sensitive adhesive (polyester polyol E-295NT: isocyanate C-55, both from Dainichiseika Color and Chemicals Mfg. Co. LTD., =100:3) was coated on the obtained thermoplastic surface layer and dried for five minutes at 100 degrees C. and to form the adhesive layer (thickness 10 μm). Then a 0.4 mm thick of ABS (from Shin-Etsu Chemical Co., Ltd.) was laminated and to give the pre-decorative sheet.

Production of the Decorative Molding

The outermost polyester film was peeled off from the obtained pre-decorative sheet at the interface with the thermoplastic surface layer, then the pre-decorative sheet was placed on a molding die (convex die) and vacuumed with heating to be along with the molding wall. The obtained molding was removed from the molding die and trimmed, then placed on another molding die (concavo die). Subsequently molten plastic (mixture of PC and ABS, NOVALLOYS S1100 from Daicel Chemical Industries, LTD) was injected and molded, then the obtained molding was removed from the die and the thermoplastic surface-protection-layer was peeled off to form the decorative molding. The relief pattern having complementary uneven pattern to the thermoplastic surface-protection-layer was made on the surface of thermoplastic surface layer of the obtained decorative molding.

1. A manufacturing method of a decorative molding having an uneven pattern by a film injection molding process with a decorative sheet comprising a thermoplastic surface layer having an uneven structure and a thermoplastic substrate layer comprising a step of producing a pre-decorative sheet, said step of producing a pre-decorative sheet comprising:
preparing a thermoplastic surface-protection-layer having an exposed uneven structured surface,
producing a thermoplastic surface layer by coating thermoplastic resin on the uneven structured surface of the thermoplastic surface-protection-layer, and
producing a substrate layer on a side of the thermoplastic surface layer opposite of the thermoplastic surface-protection-layer.

2. The manufacturing method according to claim 7 further comprising:
removing the support layer from the pre-decorative sheet, before said film injection molding process.

3. The manufacturing method according to claim 8 further comprising:
peeling the thermoplastic surface-protection-layer off from the pre-decorative sheet after the film injection molding process.

4. The manufacturing method according to claim 1, wherein the thermoplastic surface-protection-layer side of the thermoplastic surface layer has a pattern that is complementary to the uneven structured surface of the thermoplastic surface-protection-layer.

5. The manufacturing method according to claim 1, wherein said step of producing a pre-decorative sheet further comprises:
preparing a support layer, and
laminating the thermoplastic surface-protection-layer on the support layer such that the uneven structured surface is exposed.

6. The manufacturing method according to claim 5, wherein the support layer is readily removable from the pre-decorative sheet, before the film injection molding process.

7. The manufacturing method according to claim 6, wherein the support layer is laminated to the thermoplastic surface-protection-layer, during the film injection molding process.

8. The manufacturing method according to claim 2, wherein said step of preparing a thermoplastic surface-protection-layer comprises:
forming an uneven structure on a surface of the thermoplastic-surface-protection-layer, before or after said laminating, so as to form an uneven structured surface opposite the support layer.

9. The manufacturing method according to claim 5, wherein said step of preparing a thermoplastic surface-protection-layer comprises:
forming an uneven structure on a surface of the thermoplastic-surface-protection-layer, before or after said laminating, so as to form an uneven structured surface opposite the support layer.

10. The manufacturing method according to claim 6, wherein said step of preparing a thermoplastic surface-protection-layer comprises:
forming an uneven structure on a surface of the thermoplastic-surface-protection-layer, before or after said laminating, so as to form an uneven structured surface opposite the support layer.

11. The manufacturing method according to claim 7, wherein said step of preparing a thermoplastic surface-protection-layer comprises:
forming an uneven structure on a surface of the thermoplastic-surface-protection-layer, before or after said laminating, so as to form an uneven structured surface opposite the support layer.

12. The manufacturing method according to claim 2, wherein the thermoplastic surface-protection-layer side of the thermoplastic surface layer has a pattern that is complementary to the uneven structured surface of the thermoplastic surface-protection-layer.

13. The manufacturing method according to claim 3, wherein the thermoplastic surface-protection-layer side of the thermoplastic surface layer has a pattern that is complementary to the uneven structured surface of the thermoplastic surface-protection-layer.

14. The manufacturing method according to claim 5, wherein the thermoplastic surface-protection-layer side of the thermoplastic surface layer has a pattern that is complementary to the uneven structured surface of the thermoplastic surface-protection-layer.

15. The manufacturing method according to claim 6, wherein the thermoplastic surface-protection-layer side of the thermoplastic surface layer has a pattern that is complementary to the uneven structured surface of the thermoplastic surface-protection-layer.

16. The manufacturing method according to claim 7, wherein the thermoplastic surface-protection-layer side of the thermoplastic surface layer has a pattern that is complementary to the uneven structured surface of the thermoplastic surface-protection-layer.

17. The manufacturing method according to claim 8, wherein the thermoplastic surface-protection-layer side of the thermoplastic surface layer has a pattern that is complementary to the uneven structured surface of the thermoplastic surface-protection-layer.

18. The manufacturing method according to claim 9, wherein the thermoplastic surface-protection-layer side of the thermoplastic surface layer has a pattern that is complementary to the uneven structured surface of the thermoplastic surface-protection-layer.

19. The manufacturing method according to claim 10, wherein the thermoplastic surface-protection-layer side of the thermoplastic surface layer has a pattern that is complementary to the uneven structured surface of the thermoplastic surface-protection-layer.

20. The manufacturing method according to claim 11, wherein the thermoplastic surface-protection-layer side of the thermoplastic surface layer has a pattern that is complementary to the uneven structured surface of the thermoplastic surface-protection-layer.
